(19) United States
(12) Patent Application Publication
(10) Pub. No.: US 2002/0099787 A1
(43) Pub. Date: Jul. 25, 2002

(54) Distributed configuration management on a network

(75) Inventors: Brett B. Bonner, Littleton, MA (US); Grant S. Taylor, Sterling, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: 3Com Corporation

(21) Appl. No.: 09/918,876

(22) Filed: Jul. 30, 2001

Related U.S. Application Data
(60) Provisional application No. 60/261,476, filed on Jan. 12, 2001.

(51) Int. Cl. G06F 15/177

(52) U.S. Cl. 709/216; 709/220

(57) ABSTRACT

A method and system for distributed configuration management of a network. A plurality of nodes within the network each includes a database which collectively comprise a distributed database. When a node needs to store network configuration information it stores the information within its local database storage portion and transmits the information over the network for storage in at least one other peer node that utilizes the information. Each peer node stores the information within its local portion of the distributed database upon receipt. The transmitting node awaits an acknowledgement that the information has been stored by a peer. In the event no acknowledgement is received, the node retransmits the information for storage using a second command and the information is stored in other nodes whether or not they are peers of the transmitting node. In this manner, network configuration information is stored in at least two nodes within the network. The stored configuration information is retrievable by any of the nodes and is updated by each node in accordance with a defined update protocol to maintain the most current information.

### CROSS REFERENCE TO RELATED APPLICATIONS

This application claims priority of Provisional Application No. 60/261476 filed Jan. 12, 2001 and titled Distributed Configuration Management of a Network.

### BACKGROUND OF THE INVENTION

The present invention pertains to a system and method for performing configuration management in a network and more particularly to a system and method for performing configuration management in which configuration information storage and management responsibilities are distributed among the network devices.

Traditionally, network management is performed using a central management station to store and distribute configuration information within a network. The central management station is usually a high-end personal computer (PC) or Unix workstation. While the centralized approach to network configuration management is relatively simple to understand and implement, this approach suffers from a number of disadvantages. First, a system that employs a centralized management station requires a dedicated PC or Unix workstation. The dedicated management station adds to the overall system cost. Second, a centralized management station requires a skilled administrator to operate the management station. Often, it is difficult to hire appropriately skilled personnel to perform this function. Third, a centralized management station presents problems in terms of the system reliability. If the centralized station fails, the mechanism for providing network management no longer exists. For this reason, a redundant management capability may be required. Additionally, the use of a centralized device as the configuration and management station within a network imposes significant load and storage requirements on that device. This presents scalability problems as the size of the network increases and requires a more and more powerful computer to accommodate the increasing configuration and network management functions. Further, a centralized configuration and management station requires that all devices have connectivity with that station. If the network fractures for any reason, connectivity between the centralized management station may be lost. If connectivity with certain devices on the network and the centralized management station are lost, configuration and management of such devices may no longer be possible.

It would therefore be desirable to have a mechanism for performing network management and configuration that did not suffer from the drawbacks associated with a centralized management station.

### BRIEF SUMMARY OF THE INVENTION

A network configuration and management system and method are disclosed in which a group of entities within a network, such as network switches and routers, share the responsibilities of communicating, storing and retrieving network configuration information. A distributed database (DDB) is employed and a plurality of network devices is available as storage repositories. The disclosed system and method permits any entity to store a value in the DDB or request a value from the DDB. A device requesting information from the DDB need not be concerned with the identity of the particular device from which the information is to be retrieved.

In accordance with disclosed system and method, every value is stored in at least two places. More specifically, the DDB uses the concept of peer storage at a parameter level. For purposes of storing a parameter, entities are considered peers if both implement support for a particular parameter. Data is stored in the DDB as key-value pairs, where the “key” is the parameter of interest. In the common case a request for storage of a value is communicated from one entity to all other participating entities. Upon receipt of the key-value pair, all peers store the value and one of the peers confirms that the value has been stored. Since each entity stored its own data, this process assures that the key-pair value is stored in at least one other entity. In no confirmation is received at the entity that requested storage of the key-value pair, as in the case in which no peer is present, the entity that initially requested storage of the key-value pair requests that the key-value pair be stored by any other entity, irrespective of peer status.

An entity needing to access a value for a particular parameter sends a request to the DDB. Any other entity that is storing the data responds to the request. Since all devices see responses transmitted by other entities, each device that is storing the same data checks a timestamp associated with the same data to determine if its version of the stored data is up to date. If the data obtained from another entity is more current than the stored data in a particular entity, the stored data is updated.

Other advantages features and aspects of the presently disclosed system and method will be apparent from the following Detailed Description.

### BRIEF DESCRIPTION OF THE SEVERAL VIEWS OF THE DRAWING

The invention will be more fully understood by reference to the following Detailed Description in conjunction with the drawing of which:

FIG. 1 is a block diagram of a portion of a network operative in a manner consistent with the present invention;

FIG. 2 depicts the message structure used for communicating information throughout the network of FIG. 1;

FIG. 3 depicts illustrative key-value pairs;

FIG. 4 is a flow diagram illustrating an exemplary method of storing network configuration information within a distributed database;

FIG. 5 is a flow diagram illustrating an exemplary method of retrieving network configuration information from a distributed database; and

FIG. 6 is a flow diagram illustrating an exemplary method of conditionally setting parameters based upon the relative capabilities of nodes within a network.

### DETAILED DESCRIPTION OF THE INVENTION

A method and system for performing distributed configuration management in a network is disclosed. The disclosed method and system employ a distributed database (DDB) that allows for the sharing of configuration management responsibilities among a plurality of network devices or nodes.

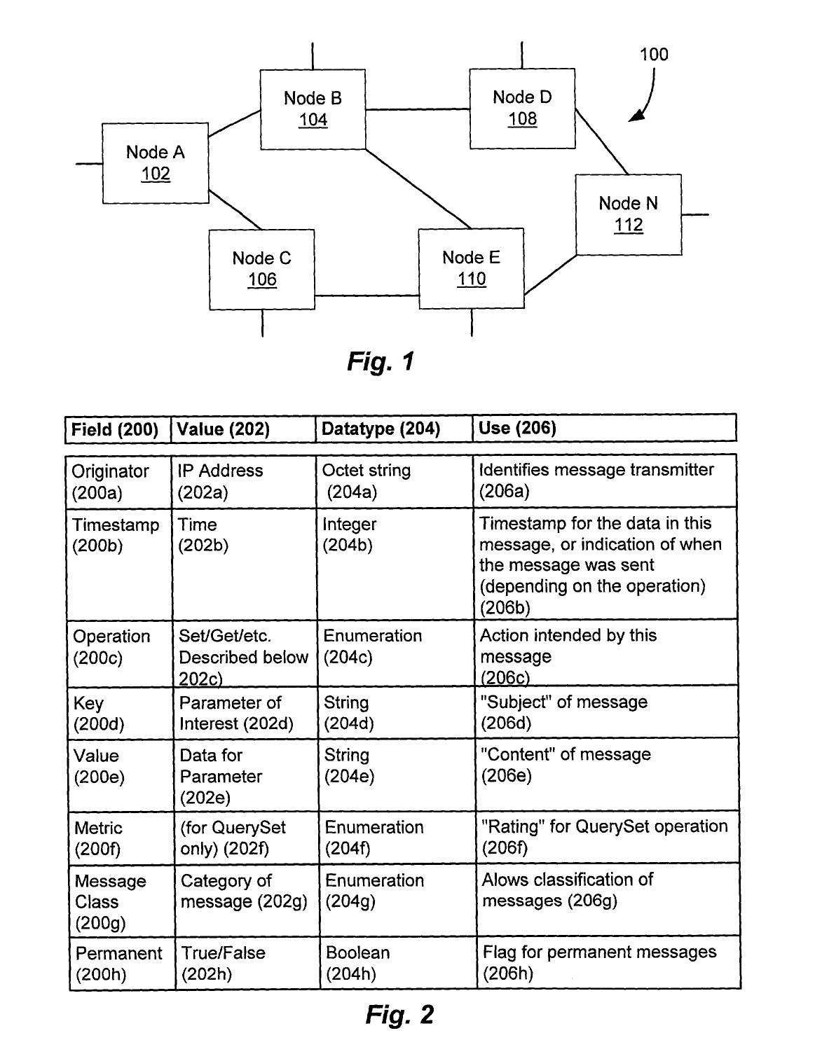

FIG. 1 depicts a portion of a network 100 operative in a manner consistent with the present invention. Referring to FIG. 1 the system includes a plurality of network nodes, namely node A 102, node B 104, node C 106, node D, 108, node E 110 and node N 112. Each of the nodes is capable of transmitting and receiving information to and from other nodes within the network 100. The network 100 may comprise a local area network, a wide area network, the Internet, a wireless network or any other suitable network for communicably coupling the respective nodes. Additionally, the network may be comprised of a combination of subnetworks with each subnetwork comprising one of the network types described above.

The network nodes depicted in FIG. 1 contain storage media such as flash RAM and/or RAM for implementing a distributed database (DDB). All participating network nodes can store a value into the DDB, or request a value from the DDB, without being concerned about which device is actually storing the value or which device is returning the value in response to a request for access. Additionally, as subsequently discussed, the system provides a mechanism for “nominating” the “most suitable” device to handle a particular task. The system and method provide for every value to be stored in at least two nodes within the network and provide a general-purpose mechanism for communicating information among the nodes. The information stored within the DDB may include network configuration information, entries describing devices to be monitored on the network, event logs, or any other data that is generated by or used by a network node.

The presently disclosed protocol utilizes the message format generally depicted in FIG. 2. The message format includes an originator field 200a, a timestamp field 200b, an operation field 200c, a key field 200d, a value field 200e, a metric field 200f, a message class field 200g, and a permanent field 200h. As illustrated in FIG. 2, the contents of the originator field 200a comprise an IP address 202a, the contents of the timestamp field 200b comprise a time value 202b, the contents of the operation field 200c comprise a value 202c that identifies the particular operation such as a SET identifier, a GET identifier, etc. The contents of the key field 200d identify the parameter of interest 202d, the contents of the value field 200e comprise the data value 202e for the parameter specified in the key field 200d,the contents of the metric field 200f comprise a value 202f used in a QUERYSET operation (discussed subsequently), the contents of the message class field 200g comprise an identifier 202g that specifies a particular message class, and the contents of the permanent field 200h comprise a true or false value 202h. The originator field 200a comprises an octet string as indicated at 204a, the timestamp 200b comprises an integer as indicated at 204b, the operation 200c comprises an enumeration of the command as indicated at 204c, the key value 200d comprises a string 204d, the value field 200e comprises a string as indicated at 204e, the metric field 200f comprises an enumeration as indicated at 204f, the message class field 200g comprises a enumeration as indicated at 204g, and the permanent field 200h comprises a boolean indicator as depicted at 204h.

The “USE” column of the FIG. 2 table identifies the use of each of the respective fields. The originator field 200a identifies the node that is transmitting the message as indicated as 206a, the timestamp field 200b provides a timestamp for the data in the message or an indication of when the message was sent depending on the operation as indicated at 206b, the operation field 200c indicates the action specified by the message as indicated at 206c, the key field 200d identifies the “subject” or parameter of interest within the respective message as indicated at 206d, the value field 200e includes the “content” or data value for the parameter specified in the key field 200d as indicated at 206e, the metric field 200f provides a “rating” for a QUERYSET operation as indicated at 206f, and the message class field 200g allows classification of messages as indicated at 206g. Message Class identifiers allow different types of communication to use the same transport mechanism; for example, the field may be used to designate “Configuration” vs. “EventLog” message classes. The permanent field 200h provides a flag that, when set, indicates that the information contained in the message should be stored in non-volatile storage as depicted at 206h.

The DDB uses the concept of peer storage at a “parameter” level. For purposes of storing a parameter, entities are considered “peers” if both implement support for a particular parameter; i.e. the key field contains the same parameter. Data is stored as key-value pairs, where the “key” is the parameter of interest. In the common case, a request for storage of a value is sent to all nodes, and all peers store the value. The same two nodes may be considered peers for one key value but may not be peers for another key value. One peer confirms storage of received information, thereby assuring the node requesting storage of the respective value that the value is now stored in at least one other place. If no confirmation of storage is received within a predetermined interval, as in the case where no peer is present, the requesting node requests that any other node stores the value.

Retrieval of data occurs as described below. A node that needs to retrieve a value for a parameter, requests that parameter from the DDB, and any other node that has the data responds. Since all nodes also see the response, other nodes storing the same data check their own timestamps and ensure that their data is up to date. If a node's stored data is not as current as the received data, the node receiving the more current data updates its stored data. If the node receiving the data contains a data value with a more current timestamp than the received data, the receiving node transmits its data over the network for receipt by all other participating nodes. This process assures that the DDB will maintain current information and will resynchronize over time.

Every entity has some amount of storage (flash RAM and/or RAM), that can be viewed as a store of DDB data. Since by definition each node is a peer of itself, it will store all its own data, plus whatever other “peer” data is present. Thus in the event the node needs to operate independently, it has all the data it needs and the data may be accessed in the usual way, i.e. by retrieving it from the DDB.

DDB communication among the nodes occurs using a reserved multicast address. All participating nodes will continuously monitor the designated multicast address, and will communicate using the presently described protocol. This protocol provides a limited number of primitive operations that allow nodes to pass data, make decisions about ownership of functions, and provide storage for configuration and event data.

Communication among the nodes may occur within a layer 2 or layer 3 domain. This could limit certain types of traffic to the bridge domain and allow communication before IP addresses are assigned while still permitting “important” communications to be handled with Layer 3, network wide, routable multicasting, such as enabling the complete database to be saved/restored to an external device such as a personal computer (PC) or a workstation. Both a layer 2 and a layer 3 multicast mechanism are provided. By providing both a layer 2 and a layer 3 multicast mechanism, a layer 2 multicast may be used for transmittal of “local” events (limited to a bridge domain), and the layer 3 multicast may be used for more general, network-wide configurations and events.

The layer 2 multicast may also be used to permit communication among the nodes before IP addresses are assigned to the respective nodes. This is useful for initial network configuration tasks, such as selecting a Dynamic Host Configuration Protocol (DHCP) server for the network.

The fundamental data component of a DDB message is its key/value pair. The originator and timestamp identify who sent the message and the age of the data.

The Operation describes the action associated with the respective DDB message. Finally, the “Permanent” field is used in conjunction with a Set operation, and indicates that the value should be stored in a non-volatile store such that it persists across reboots (e.g. in flash RAM); the alternative is Temporary storage, which is useful for non-critical values that are not retained in the event of a reboot, aging out, lack of space, etc.

### DDB Operations

The DDB in the illustrated embodiment supports the following operations:

### Set Operation

The Set Operation is a request by a node that a parameter be stored in the DDB. In response to the receipt of a Set Operation every peer node, that is, any other node which implements that parameter, configures the value of this parameter if the timestamp of the Set Operation is newer than the previous setting. A node responds to a Set Operation with a SetConfirm Operation. The node that forwarded the Set Operation is the “root” node for this parameter. If a receiving node receives a Set Operation that includes a timestamp older than the timestamp already stored in the node for that parameter, then the receiving node sends its own Set Operation using the newer data. This allows a network that has somehow diverged due to a failure, to automatically resynchronize to the newer values. A node that has issued a Set Operation and then immediately sees a Set Operation for the same value with a newer timestamp, aborts its own Set Operation and ceases to await receipt of a SetConfirm Operation. The node that issued the Set Operation adopts the newer value within the DDB.

### SetConfirm Operation

The SetConfirm Operation is issued by a node to confirm that it has received a Set or SetRetry Operation and stored the parameter specified in the respective Operation. If the confirming entity is a peer, it is implied that it has also configured the parameter. The SetConfirm Operation is sent after a small random delay, if and only if (IFF) no other SetConfirm Operation for the same parameter was received during the delay period. For example, delay periods of tens to hundreds of milliseconds may be employed in a typical local area network. Additionally, any other suitable delay periods may be employed. Moreover, the delay parameter may be tuned depending upon specified design objectives. The receipt of the SetConfirm Operation by the root node informs the root node that there is at least one other node on the network that has stored the parameter specified in the Set Operation.

### SetRetry Operation

A SetRetry Operation is issued by a node when a Set Operation was issued, but no SetConfirm was received back. This indicates no peer was present on the network. The node issuing the Set Operation issues a SetRetry Operation, requesting that any available node store the parameter regardless of whether the receiving node implements the parameter.

### Get Operation

A node issues a Get Operation to request that a value of a parameter be retrieved from the DDB. Any node that is maintaining a value for that parameter within the DDB responds with a SendData Operation, using the same algorithm as used for the SetConfirm Operation as described above.

### SendData

A SendData operation is used by a node to return the value requested by a node via a Get Operation. Any node storing the requested value can respond (again after a small random delay). The node returning a value applies a timestamp within the SendData message that corresponds to the timestamp of the stored data. All other nodes observe the SendData message. If any node is storing the same data, it checks the timestamp of the received SendData message and takes some action based on a comparison of the received SendData message timestamp and the timestamp of the corresponding stored data. More specifically, if the timestamps within the received SendData message and the stored data are the same, the node that received the SendData message takes no action. If the timestamp on the stored data is older than the timestamp associated with the received SendData message, then the receiving node updates its own value, configures the node accordingly, and associates the received timestamp with the value received via the SendData message. If the timestamp of the stored data is newer than the timestamp associated with the received SendData message, then the node transmits its own SendData message that includes its stored data. The transmission of the SendData message by the node containing data with the more recent timestamp causes other nodes to synchronize to the newer value.

### Queryset

The QuerySet Operation is used to negotiate which node will provide a particular service as identified by the message key. Via the QuerySet message, a node issues a “conditional set” of a parameter, with an associated metric. If any other node has a higher metric for the same parameter, it issues its own QuerySet message, which will supersede the first one. When no node has issued a superseding QuerySet message for a predetermined period of time, the last node to issue a QuerySet message issues a Set message for the parameter. Use of the QuerySet message allows devices with varying levels of capability to negotiate so that the most capable device provides a particular resource or service. For example, the QuerySet operation may be used during initialization of the network. During initialization it is often necessary to choose a device to act as a DHCP server. The DHCP server assigns Internet Protocol (IP) addresses to other devices on the network. Devices may vary in the level of DHCP capability provided due to hardware differences and varying software implementations. Further, depending on the network architecture, a device's position or function in the network (for example, at a gateway to another network) may render it more or less suitable to act as DHCP server. By using the QuerySet mechanism, each device can “rate” its own ability to provide the particular service or resource needed, and the network will use the device with the highest rating.

### Key/Value Pairs

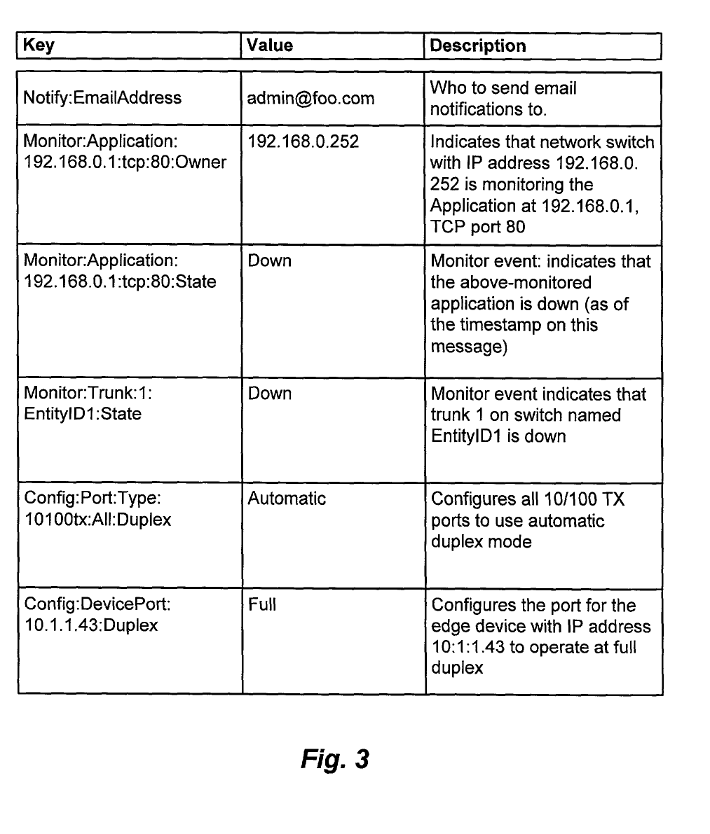

A key value pair includes a key and a value. A number of exemplary key/value pairs along with a description of each are depicted in FIG. 3. The key uniquely identifies the parameter or event of interest, and the value is the data associated with that parameter or event. In the illustrated embodiment, keys are colon-separated strings with hierarchical meaning. Values will take different forms depending on the key. Keys contain enough identifying information to permit a node to determine whether a particular key applies to it, or not. The key hierarchy allows a node to determine the scope of a parameter.

An exemplary key/value pair is depicted below:

Config:Protocol:Sntp:PollInterval

The key configures the Simple Network Time Protocol (SNTP) polling interval (the interval itself is the “value” associated with this key). This is a global value that applies across all devices; there is no qualifier to limit its scope. All devices store this value.

Another example of a key is depicted below:

Config:Port:DevicePort:1-8:MyEntityID:Duplex This is another configuration message, which applies to Ports 1-8 on device MyEntityID and sets the duplex mode. This setting is stored by the requesting device, but there is no peer since there is no other device to which this message applies because Entity ID's must be unique. “EntityID” is an identifier unique to each node, such as a name or MAC address. Therefore a SetRetry is sent in the absence of the receipt of a SetConfirm message and some other node stores the value.

One special key has been defined which is handled differently than the keys described above. This is referred to herein as “Allkeys”. More specifically, if the requested data key is “AllKeys”, then the node always responds to a Get request, sending data with the key “AllKeys:EntityID”. The node transmits as the associated value the complete list of all keys it is presently storing which have the same MessageClass as the Get request. This limits an AllKeys message to the MessageClass of interest. Consequently, the size of the response data is reduced. Limiting the size of the response date is beneficial because frequently the requester will only be interested in a particular class of messages such as “Configuration”. More specifically, all devices respond to a Get request for “AllKeys” by returning a SendData with the key “AllKeys:EntityID” and a data field of a comma separated list of all keys presently stored on that entity that are of the same MessageClass as the Get request. The requesting device can then use the received key lists to construct a list of all keys stored anywhere on the network, and request the data of interest to it. For example: an application may use this mechanism to back up the complete database, and a brand-new device can use it to determine what keys exist that apply to it, and request only those values.

### MessageClass

The MessageClass is used for categorizing messages. Two types of MessageClass include “Configuration” and “Event” messages. These may be handled differently by a node. For example, Configuration messages may be assigned a higher priority and require authentication, while Event messages may be assigned a lower priority and not require authentication. While Configuration and Event messageclasses are two examples of messageclasses, devices may support additional messageclass types.

The MessageClass attribute allows the DDB to be used for various types of communication without overloading either the nodes or links. For example, a very simple node may handle only the Configuration MessageClass. Even full-fledged devices may reduce the DDB impact by, for example, not implementing full redundancy checking for Events or other message types.

### “Permanent” Attribute

The Permanent attribute allows for some messages, such as configuration and important monitoring events, to be logged into flash RAM or other persistent memory while other messages are cached in RAM but do not persist across reboots and can be aged out as appropriate. For example, the network may log a cached event to note when the last Notification for a particular event was sent to the network administrator. If that event recurs, a device can then look up the value from the DDB and decide whether or not another Notification should be sent. Additionally, low-priority network-monitoring events could be logged only as nonpermanent occurrences in order to minimize usage of limited flash memory space within a node.

### Load Distribution

It is desirable that the DDB neither cause one device to do all the database work, nor burden all devices by introducing excessive redundancy. In the presently disclosed system there is very little risk that one device will be overburdened with “central” responsibilities. However, it is desirable to avoid excess redundancy.

The random delays employed for responsive messages assist in reducing the number of duplicate responses. Because each response to a Set or a Get is made after a random delay, it ensures that only one device (in most cases) will actually generate a response. The more capable nodes may be favored so that that they respond after a shorter delay and hence bear more of the load. Parameters with no peer, e.g. entity specific values, will rely on the SetRetry method for storage, which results in minimal duplication of effort among nodes. Entities with less capability are likely to implement fewer parameters and configuration options, and are therefore “peers” of fewer parameters. Their storage requirements will be correspondingly reduced.

For event storage, several approaches may be employed to reduce storage needs. For example, in a large network with multiple subnetworks, events may be forwarded only to Layer 2 domains, so that they are stored only within the particular subnetwork to which they relate. Additionally, nodes with limited storage may employ strategies to reduce the amount of data maintained, such as allowing events to expire more quickly or not storing lower priority events. Furthermore, a node with very limited storage resources may opt to ignore Events entirely, and participate in the DDB only for configuration messages.

### Bulk Save

One of the Configuration requirements is that it be possible to save/restore the entire DDB to an external entity. This requirement enables the network administrator to use an application running on a personal computer to archive the contents of the DDB for recordkeeping and additional backup, and to restore a previous configuration should that become necessary. This is made possible through the Special key “AllKeys”, described above. A PC application issues a Get request for “AllKeys”. It would receive back one key:value pair per device, where the key identifies the responding device, and the value is the list of all keys on that device. The application parses these lists, removing the duplicates, and generates a list of all unique keys stored anywhere on the network. The application then issues Get requests for each key and stores the responses.

### Bulk Restore

To perform a bulk restore operation the application issues Set Operations for each key it has backed up, and ensures that a SetConfirm is received for each. If there is no SetConfirm, then a SetRetry is used-although if no device believes the parameter applies to it, then this may be an “obsolete” parameter. For example, no SetConfirm would be received for a parameter that pertains only to a device that is no longer part of the network.

This approach only assures that a single node on the network (plus the application) is storing the value. Since this condition can arise under other circumstances, discussed below in the section titled “Redundancy Checking” section, the network detects and fixes this condition. Therefore the application may assume that the network's redundancy checking will take care of this issue.

### Auto-configuration of a New Device

When a new node joins the network, it must assume all of the required settings. Two alternatives need to be considered. The first is when the joining node represents a new node. The second case is when the joining node represents a replacement for an existing node.

In the case of a new node, the settings for an equivalent peer node are employed. For example, a new edge switch is configured like the other edge switches in the network. In this circumstance, the switch will boot using its default configuration, locate a DHCP server and obtain an IP address, and then use a Get:AllKeys request for the Configuration MessageClass to obtain lists of configuration keys stored in each device. It will parse these lists and determine the keys for which it is a peer. For instance, it is a peer for all global keys, anything applying to its port types, etc. The newly added node then requests values for each applicable key, configures itself, and stores the values in its own DDB store.

In some cases, a new node may be able to determine correct settings on its own through auto-detection, even without the DDB. Nonetheless, the DDB may be able to provide information more rapidly or more efficiently, and is required to provide any of the data that cannot be automatically determined (e.g. the network administrators'email addresses). Also, having the new node absorb all applicable peer settings increases redundancy of storage.

The replacement node situation is similar, except that any keys applicable to its predecessor's EntityID should also apply to the replacement node. This is complicated by the fact that the logical choices for EntityID (MAC address, serial number) differ between the original node and the replacement node. Therefore, if the capability of automatic replacement-node configuration is important, one solution is to use keys that identify a connected device rather than a particular network node. In this way a replacement node can, through knowledge of its surrounding and connected devices, identify which keys apply to it. For example, there might be a need to identify settings for a port that connects to a particular server. Rather than use a key like “Config:Port:l:EntityFoo:DuplexMode”, which would identify the setting for Port 1 on the EntityFoo network node, a better choice would be “Config:DevicePort:10.0.0.1:DuplexMode” indicating the duplex mode for the 10.0.0.1 server's connection. Then, any device which detected it was providing connectivity 10 to the 10.0.0.1 server, would know that this setting applied to it. This also provides the benefit that if the server is moved to another switch, the setting will follow.

### Redundancy Checking

The design of the DDB ensures that no parameter is stored in only one device-therefore there is no single point of failure that will result in loss of data.

However, what if an entity storing the only duplicate copy of a piece of data fails and is replaced? The new entity does not necessarily know that it needs to retrieve that data and store a copy, particularly if the original entity stored it as the result of a SetRetry rather than as a peer. Likewise, if an external application restores configuration settings, it can only confirm that one entity on the network is storing the data; there is no guarantee that a second copy was stored. To address this problem periodic redundancy checking in provided. In keeping with the decentralized architecture proposed, each node will be responsible for ensuring that its data is stored somewhere else. This will be done by a slow “trickle” check. Each node will periodically issue a Set message for a Configuration parameter it is storing. In an illustrative embodiment, the period is a number of minutes. The node issuing the Set message expects to receive back a SetConfirm within a specified period of time. If no SetConfirm is received, a SetRetry message is issued. Following the specified period, the respective node issues a Set message for the next parameter it is storing. The node repeatedly issues Set messages through all values and then repeats the process starting at the initial value. In this way the DDB is continuously updated. This process has the additional advantage of providing a mechanism for automatic recovery from an event that fractures the network. Should the network fracture, it is possible that a change to DDB data may occur on one subsection of the network but due to the fracture, will not propagate to all nodes. When the subsections rejoin, the redundancy check will ensure that all devices are updated. There are two possible mechanisms for this to occur. If a device which has a newer value issues its periodic Set first, then devices maintaining an older value will see the data with a newer timestamp and update themselves accordingly. Alternatively, should one of the devices holding older data attempt a periodic Set of the data before any newer device, then the newer device will see the attempt, note that it has a newer value, and immediately send that out, causing all devices to update.

In order to better distribute traffic over time, it may be desirable to randomize the redundancy checking interval so devices do not tend to conflict. This mechanism may also be used to handle configuration of new nodes, although it would be slow to do so since the settings would “trickle” out to the new device over a long period of time.

Likewise if the interval were temporarily reduced to something quite short, the effect would be to force a dump of all configuration data in all nodes, over a short period of time. This is an alternate way for an external application to gather the complete configuration.

If the automatic redundancy checks generate excessive traffic, an enhancement may optionally be provided in the form of a field that is added to each message stored in the DDB. This field would store a “last checked” timestamp. Any node that receives a Set request for that parameter would update its local timestamp, indicating it has been recently verified. Then, when performing the redundancy checks, it would skip any parameter with a “last checked” timestamp that is less than some number of minutes old.

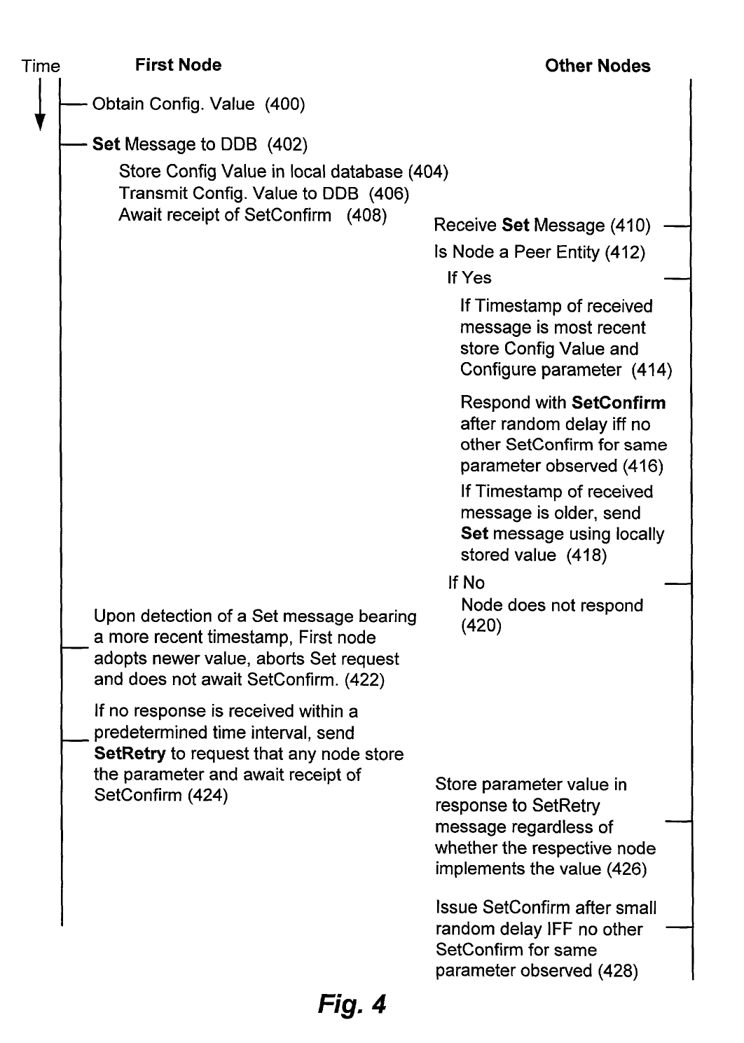

FIG. 4 depicts a flow diagram of functionality for storing data within the DDB. As depicted in FIG. 4, a first node obtains a configuration value as depicted in step 400. The node then initiates a Set Operation as indicated in step 402. This operation includes the storing of the configuration value within the local storage for the respective node as illustrated at step 404 and transmitting a Set message to the DDB as depicted at step 406. The node initiating the Set Operation awaits receipt of a SetConfirm message as depicted at step 408.

Other nodes receive the Set message as depicted as step 410. The discussion of the processing listed under “Other Nodes” in FIG. 4 occurs at each of the other nodes. The respective “other node” determines whether the received Set message pertains to a peer node as illustrated as step 412. If the message pertains to a peer node, the receiving node determines if the timestamp of the received message is more recent than the timestamp associated with the relevant data stored in the respective node as shown in step 414. If the timestamp of the received message is more recent than the stored data, the message data is stored in place of the stored data along with the received timestamp and the node is configured using the received parameter. The respective node then responds to the Set message after a random delay with a SetConfirm message if and only if no other SetConfirm message for the same parameter was seen by the respective node as illustrated as step 416.

If the timestamp of the received message is older than the timestamp of the relevant stored data, the respective node initiates its own Set Operation using its locally stored data as illustrated at step 418.

If it is determined by the node receiving the Set message that the receiving node is not a peer of the node initiating the Set Operation, the receiving node does not respond as illustrated at step 420.

As shown at step 422, if the First Node, i.e. the node initiating the respective Set Operation, detects a Set message for the same parameter bearing a more recent timestamp than that associated with its locally stored data, the node aborts its Set Operation, does not await a SetConfirm message and stores and configures the received parameter.

Additionally, if the First Node initiates a Set Operation and does not receive a response within a predetermined time interval, the node initiates a SetRetry Operation and awaits receipt of a SetConfirm message as depicted at step 424.

In response to receipt of a SetRetry message, each receiving node stores the data contained within the respective message regardless of whether the respective receiving node is a peer as depicted in step 426 and issues a SetConfirm message after a small random delay if and only if no other SetConfirm for the same parameter has been observed as depicted in step 428.

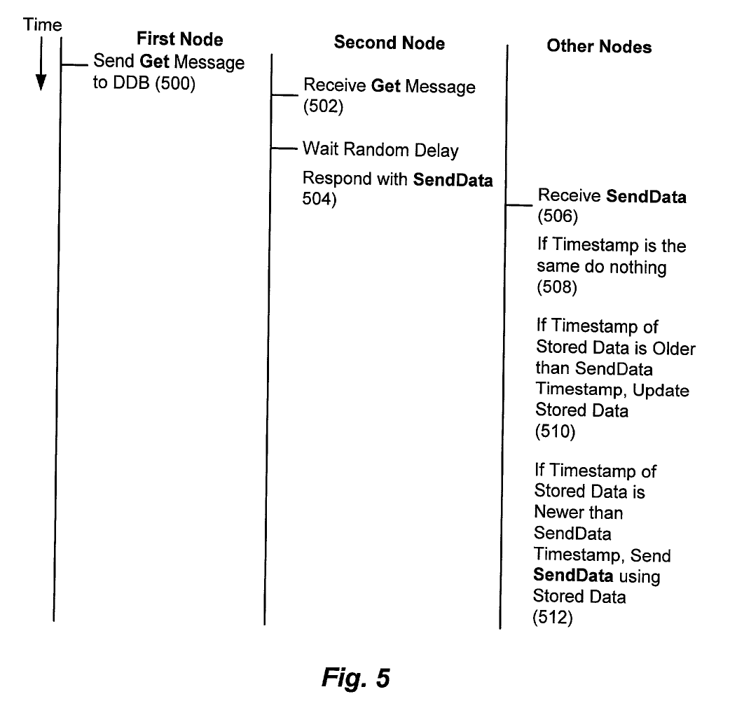

FIG. 5 depicts a flow diagram illustrating the technique for data retrieval from the DDB. A node desiring to retrieve a value from the DDB issues a Get Operation as illustrated in step 500. A second node receives the Get message as shown at step 502. If the receiving node is storing the parameter specified in the Get message, that node waits a small random delay and responds with a SendData message as depicted in step 504. Other nodes in the network receive the SendData message as shown in step 506. The processing at each of the other nodes is the same. If the timestamp in the

SendData message is the same as the timestamp of the relevant stored data at the respective other node, the node does nothing as depicted in step 508.

If the timestamp of the stored data at the respective other node is older than the timestamp of the SendData message, the respective node updates the value of the relevant parameter and configures the parameter as depicted at step 510.

If the timestamp of the stored data at the respective other node is newer than the SendData timestamp, then the node sends its own SendData message using its own stored data as shown in step 512.

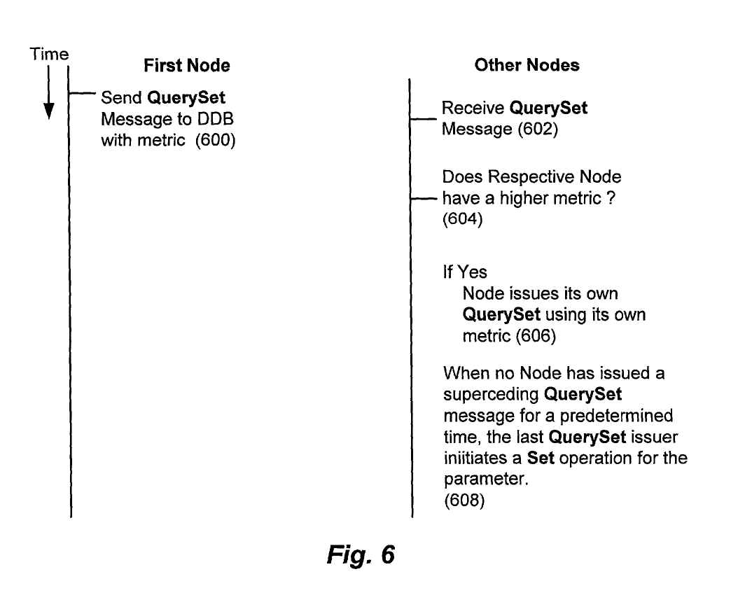

FIG. 6 depicts a flow diagram illustrating the technique for conditionally setting a parameter within the DDB. When a node desires to conditionally set a parameter within the DDB it issues a QuerySet message to the DDB with a metric as depicted in step 600. The metric is indicative of the capability of the issuing node in some respect. For example, the metric may be indicative of processing speed, storage capacity, bandwidth, etc. Other nodes receive the QuerySet message as illustrated in step 602. Each node that receives the QuerySet message determines whether it has a higher metric with respect to the parameter specified in the QuerySet message as depicted in step 604. If a node has a higher metric with respect to the relevant parameter, that node issues its own QuerySet message with its own metric as shown in step 606. When no node has issued a superceding QuerySet message for a predetermined period of time, the last QuerySet message issuer initiates a Set operation for the relevant parameter as illustrated in step 608.

It will be appreciated by those of ordinary skill in the art that modifications to and variations of the above-described methods and system may be made without departing from the inventive concepts disclosed herein. Accordingly, the invention should not be viewed as limited except as by the scope and spirit of the appended claims.

What is claimed is:

1. A system for distributing network management information comprising:
a plurality of network devices, each of said plurality of network devices communicably coupled to at least one other one of said plurality of network devices via a network, each one of said plurality of network devices including a local database, wherein said local databases in said plurality of network devices collectively comprise a distributed database;
a first one of said plurality said network devices operative to store predetermined network configuration information and an associated timestamp in its local database and being further operative to transmit a first message including said predetermined network configuration information and said timestamp over said network for storage in at least one other local database in another one of said network devices; and
at least one network device other than said first one of said plurality of network devices being operative to receive said predetermined network configuration information and to store said information within its respective local database.

2. The system of claim 1 wherein said at least one network device other than said first one of said plurality of network devices is further operative to transmit a second message over said network indicating that it has stored the predetermined network configuration information within its local database.

3. The system of claim 1 wherein said at least one network device other than said first one of said plurality of network devices is operative to store said predetermined network configuration within its local database only if it has at least one predetermined characteristic in common with said first one of said network devices.

4. The system of claim 3 wherein said at least one network device other than said first one of said plurality of network devices is further operative to transmit a second message over said network indicating that it has stored the predetermined network configuration information within its local database.

5. The system of claim 4 wherein said first one of said plurality of network devices is further operative to transmit a third message to said other ones of said network devices requesting that the predetermined network configuration information be stored within each recipients local database in the event said first one of said network devices does not receive said second message within a predetermined interval following transmission of said first message, wherein said third message comprises a request to store the predetermined network configuration information within the local database of each one of said network device that receives the third message irrespective of whether the respective receiving network device has said at least one predetermined characteristic in common with said first one of said plurality of network devices.

6. The system of claim 1 wherein a second one of said network devices being operative to transmit a retrieval request over said network for retrieval of said predetermined network configuration, wherein at least one of said network devices that include said network management information within its respective local database is operative in response to said request to transmit said network management information and the associated timestamp over said network to said other ones of said network devices.

7. The system of claim 1 wherein at least one of said network devices other than said first one of said network devices is operative to store in the respective local database said predetermined network configuration information received at the respective network device in the event:
(a) said network management information received at the respective network device is not included within the database for that network device; or
(b) a version of the information received at the respective network device is included within the database for the receiving network device but the timestamp for the received information is more recent than the timestamp for said version stored at said receiving device.

8. The system of claim 1 wherein at least one of said network devices other than said first one of said network devices is operative to:
identify whether the respective network device is storing a version of the predetermined network configuration information within its respective local database; and
in the event the respective network device is storing a version of the predetermined network configuration information within its local database:
(a) store in the local database the received predetermined network configuration information in the event the timestamp associated with the received predetermined network configuration information is more recent than the timestamp associated with the corresponding predetermined network configuration information within the local database; and
(b) transmit for receipt by said other ones of said network devices an update message that includes the predetermined network configuration information and the associated timestamp contained within the local database in the event the timestamp associated with the predetermined network configuration information stored within the local database is more recent than the timestamp associated with the received predetermined network configuration information.

9. The system of claim 1 wherein said first message includes a key and a value wherein said key comprises an identify a parameter and said value comprises data associated with said parameter.

10. A method for maintaining network configuration information comprising the steps of:
including a local database in each one of a plurality of communicably coupled network devices, wherein said local databases in said network devices collectively comprise a distributed database;
at a first one of said network devices, storing predetermined network configuration information and an associated timestamp within the respective local database and transmitting a first message including said predetermined network configuration information for receipt by at least one other network device; and
storing said predetermined network configuration information and said timestamp in the local database of each one of said other network devices in the event the respective network devices have a message parameter that is common to a corresponding message parameter within said first one of said network devices.

11. The method of claim 10 further including the step of communicating a confirmation message from at least one of said other network devices to said first one of said plurality of network devices upon storage of said predetermined network configuration information within the respective local database.

12. The method of claim 10 further including the steps of:
issuing a retrieval request from a second one of said plurality of network devices to said distributed database for retrieval of said predetermined network configuration information; and
in response to receipt of said request at at least one of said other network devices that is storing the predetermined network configuration information within its local database, transmitting said information and the associated timestamp over said network.

13. The method of claim 12 further including the step of storing said information transmitted over said network and received at at least one of said other network devices on the respective local database in the event (a) said information received at the respective network device is not included within the local database for the respective network device; or (b) information corresponding to said predetermined network configuration is stored within the local database for the receiving network device but the timestamp for the received information is more recent than the timestamp for the corresponding predetermined network configuration information stored within the respective local database.

14. The method of claim 13 wherein said storing step is performed only if a parameter identifier within the local database corresponds to a parameter identifier within said first one of said network devices.

15. The method of claim 10 wherein said first message includes a memory designator attribute having one of a first state and a second state, said local database within each network device includes a non-volatile memory portion and a volatile memory portion and said storing step includes the steps of storing said predetermined network configuration information in said non-volatile memory portion of said local database in the event said memory designator attribute is of said first state and storing said predetermined network configuration in said volatile memory portion of said local database in the event said memory designator attribute is of said second state.

16. A system for maintaining network configuration information comprising:
means for storing information in a local database in each one of a plurality of communicably coupled network devices wherein said local databases in said network devices collectively comprise a distributed database;
at a first one of said network devices, means for storing predetermined network configuration information and an associated timestamp within the respective local database and transmitting a first message including said predetermined network configuration information for receipt by at least one other network device; and
means for storing said predetermined network configuration information and said timestamp in the local database of each one of said other network devices in the event the respective network devices have a message parameter that is common to a corresponding message parameter within said first one of said network devices.
